(19) United States
(12) Patent Application Publication
(10) Pub. No.: US 2025/0130794 A1
(43) Pub. Date: Apr. 24, 2025

(54) MULTI-FORMAT OPERAND CIRCUIT

(71) Applicant: Advanced Micro Devices, Inc., Santa Clara, CA (US)

(72) Inventors: Shubh Shah, Santa Clara, CA (US); Ashutosh Garg, Folsom, CA (US); Bin He, Orlando, FL (US); Michael Mantor, Orlando, FL (US); Shubra Marwaha, Santa Clara, CA (US); Subramaniam Maiyuran, Folsom, CA (US)

(73) Assignee: Advanced Micro Devices, Inc., Santa Clara, CA (US)

(21) Appl. No.: 18/399,659

(22) Filed: Dec. 28, 2023

Related U.S. Application Data
(60) Provisional application No. 63/591,963, filed on Oct. 20, 2023.

(51) Int. Cl. G06F 9/30

(52) U.S. Cl. CPC G06F 9/30007; G06F 9/30145

(57) ABSTRACT

The disclosed processing circuit can perform an operation with a first operand having a first number format and a second operand having a second number format by directly using the first operand in the first number format and the second operand in the second number format to produce an output result. Various other methods, systems, and computer-readable media are also disclosed.

### CROSS REFERENCE TO RELATED APPLICATION

This application claims the benefit of U.S. Provisional Application No. 63/591,963, filed 20 Oct. 2023, the disclosure of which is incorporated, in its entirety, by this reference.

### BACKGROUND

Floating point numbers are commonly used by computing devices to represent a wide range of real number values for computations. Different floating point number formats can be configured for various considerations, such as storage space/bandwidth considerations, computational considerations, mathematical properties, etc. Further, different computing devices can be configured to support different formats of floating point numbers. As computing devices become more complex (e.g., having different types of hardware working in conjunction, using networked devices, etc.), and computing demands increase (e.g., by implementing machine learning models, particularly for fast decision making), support for different floating point number formats can be desirable. Although software-based support for different floating point number formats is possible, software support often incurs added latency or can otherwise be unfeasible for particular application requirements.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for multi-format operand circuits.

FIGS. 2A-C are diagrams of example floating point number formats.

FIG. 3 is a simplified block diagram of a circuit for multi-format operands.

FIG. 4 is a flow diagram of an exemplary method for multi-format source operands.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to a multi-format source operand circuit. As will be explained in greater detail below, implementations of the present disclosure perform an operation directly with a first operand having a first number format and a second operand having a second number format. By producing an output result without first converting either of the first or second operands into a number format common to both, the systems and methods described herein improve computer processing efficiency, and provides further flexibility when performing computations on values from different sources (e.g., other processing components and/or devices). In addition, the systems and methods provided herein can improve the technical field of machine learning by allowing improved decision and greater hardware compatibility making by maintaining fast processing while reducing overhead for converting values into a shared number format.

In one implementation, a device for multi-format operands includes a processing circuit configured to perform an operation with a first operand having a first number format and a second operand having a second number format by directly using the first operand in the first number format and the second operand in the second number format to produce an output result.

In some examples, the first number format and the second number format correspond to different number formats of a plurality of number formats that have a similar precision. In some examples, the processing circuit is configured to perform the operation for each of a plurality of possible combinations of the plurality of number formats for the first operand and the second operand. In some examples, the processing circuit includes circuitry, for each of the plurality of possible combinations, to perform the operation. In some examples, the processing circuit includes instruction sets, for each of the plurality of possible combinations, to perform the operation.

In some examples, the processing circuit is further configured to decode the operation into micro-operations that use the first number format and the second number format. In some examples, the micro-operations include micro-operations for normalizing a first sign, a first exponent, and a first mantissa of the first operand based on the first number format and normalizing a second sign, a second exponent, and a second mantissa of the second operand based on the second number format. In some examples, the micro-operations include micro-operations for combining the first sign with the second sign, the first mantissa with the second mantissa, and the first exponent with the second exponent in accordance with the operation to produce the output result.

In one implementation, a system for multi-format operands includes a memory, a processor, and a processing circuit configured to (i) receive, for an operation, a first operand having a first number format and a second operand having a second number format, (ii) decode the operation into micro-operations that use the first number format and the second number format, and (iii) perform the operation via the decoded micro-operations that directly use the first operand in the first number format and the second operand in the second number format to produce an output result.

In some examples, the first number format and the second number format correspond to different number formats of a plurality of number formats that have a similar precision. In some examples, the processing circuit is configured to decode the operation into micro-operations by selecting the micro-operations corresponding to one of a plurality of possible combinations of the plurality of number formats for the first operand and the second operand. In some examples, the processing circuit is further configured to select the micro-operations based on a first source of the first operand and a second source of the second operand. In some examples, the processing circuit includes circuitry corresponding to each of the plurality of possible combinations to perform the operation.

In some examples, the micro-operations include micro-operations for normalizing a first sign, a first exponent, and a first mantissa of the first operand based on the first number format and normalizing a second sign, a second exponent, and a second mantissa of the second operand based on the second number format. In some examples, the micro-operations include micro-operations for combining the first sign with the second sign, the first mantissa with the second mantissa, and the first exponent with the second exponent in accordance with the operation to produce the output result.

In one implementation, a method for multi-format operands includes (i) identifying a first number format for a first operand of an operation and a second number format for a second operand of the operation, wherein the first number format and the second number format correspond to different number formats that have a similar precision, (ii) selecting, based on the first number format and the second number format, a set of instructions that use the first number format and the second number format to perform the operation, (iii) performing the operation by directly using the first operand and the second operand with the selected set of instructions to produce an output result.

In some examples, selecting the set of instructions is based on the first number format and the second number format. In some examples, selecting the set of instructions is based on a first source of the first operand and a second source of the second operand. In some examples, performing the operation further comprises normalizing a first sign, a first exponent, and a first mantissa of the first operand based on the first number format, and normalizing a second sign, a second exponent, and a second mantissa of the second operand based on the second number format. In some examples, performing the operation further comprises combining the first sign with the second sign, the first mantissa with the second mantissa, and the first exponent with the second exponent in accordance with the operation to produce the output result.

Features from any of the implementations described herein can be used in combination with one another in accordance with the general principles described herein. These and other implementations, features, and advantages will be more fully understood upon reading the following detailed description in conjunction with the accompanying drawings and claims.

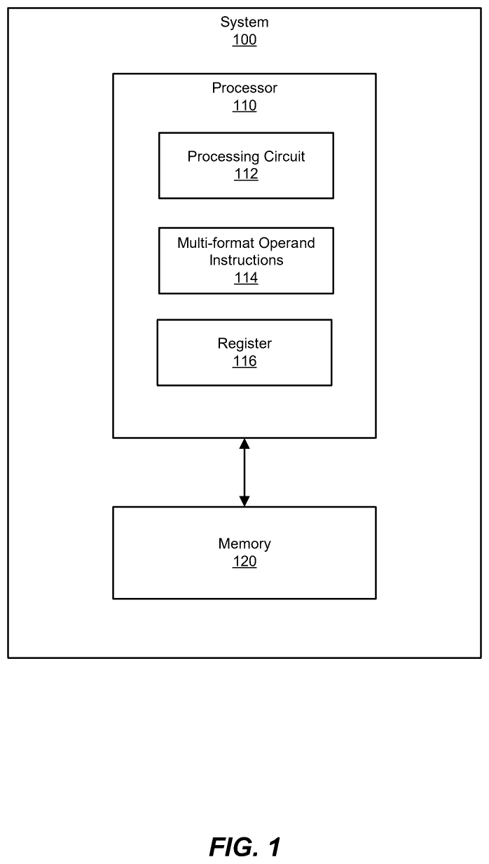

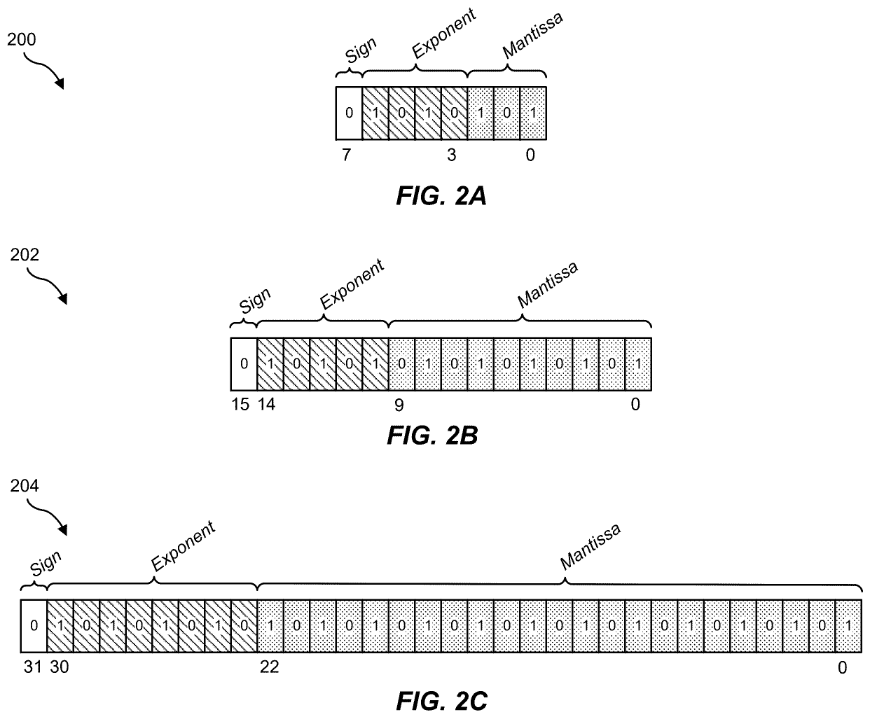

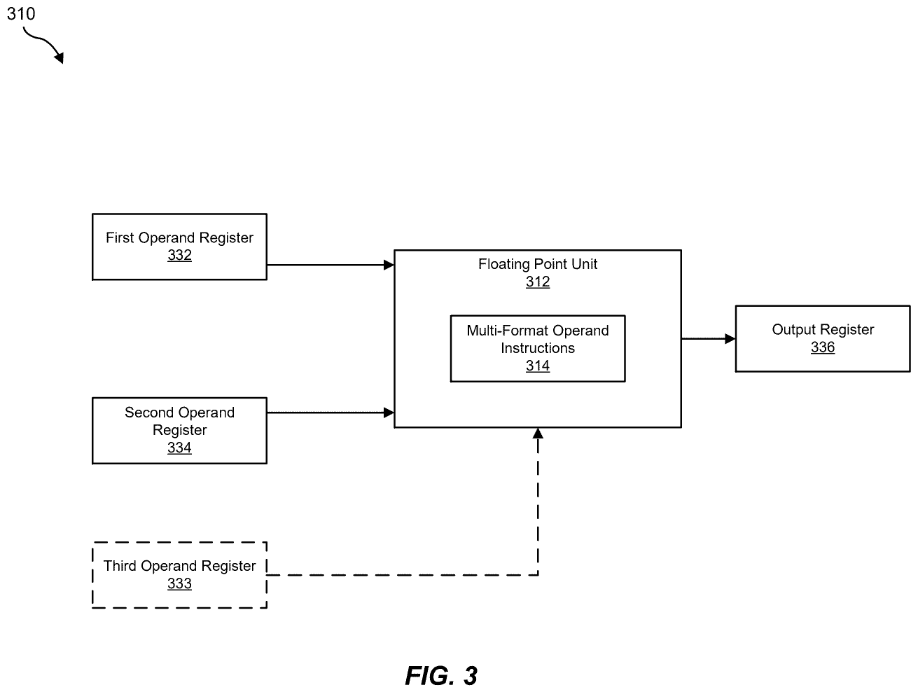

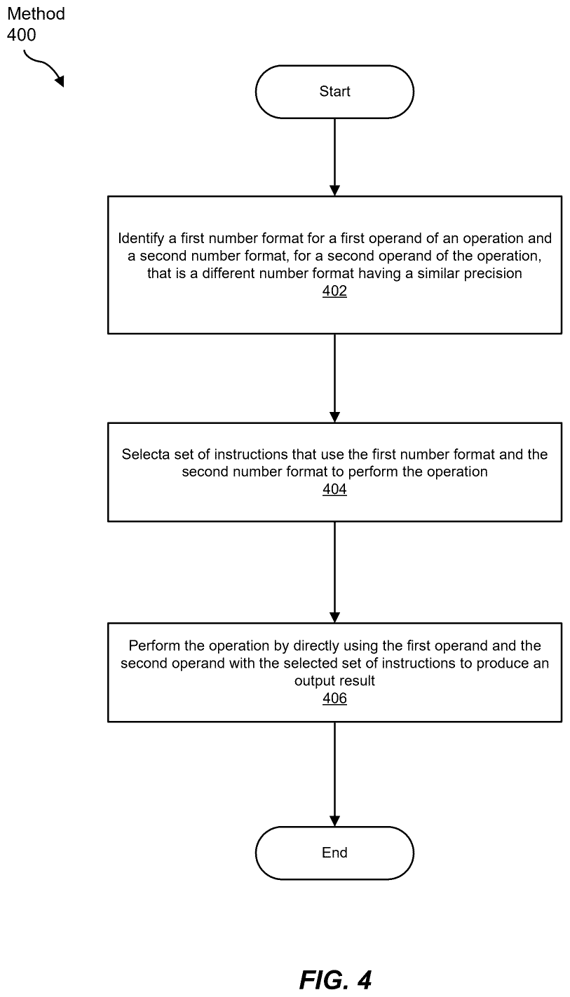

The following will provide, with reference to FIGS. 1-4, detailed descriptions of hardware-based multi-format operand processing. Detailed descriptions of example systems and circuits will be provided in connection with FIGS. 1 and 3. Detailed descriptions of floating point number formats will be provided in connection with FIGS. 2A-2C. Detailed descriptions of corresponding computer-implemented methods will also be provided in connection with FIG. 4.

FIG. 1 is a block diagram of an example system 100 for hardware-based stochastic rounding of floating point numbers. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110, which can correspond to one or more processors (e.g., a host processor along with a co-processor, which in some examples can be separate processors). Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, one or more instances of chiplets (e.g., smaller and in some examples more specialized processing units that can coordinate as a single chip), microprocessors, microcontrollers, Central Processing Units (CPUs), graphics processing units (GPUs), Field-Programmable Gate Arrays (FPGAs) that implement softcore processors, Application-Specific Integrated Circuits (ASICs), systems on chip (SoCs), co-processors such as digital signal processors (DSPs), Neural Network Engines (NNEs), accelerators, portions of one or more of the same, variations or combinations of one or more of the same (e.g., a host processor and a co-processor), and/or any other suitable physical processor(s).

In some implementations, the term “instruction” refers to computer code that can be read and executed by a processor. Examples of instructions include, without limitation, macro-instructions (e.g., program code that requires a processor to decode into processor instructions that the processor can directly execute) and micro-operations (e.g., low-level processor instructions that can be decoded from a macro-instruction and that form parts of the macro-instruction). In some implementations, micro-operations correspond to the most basic operations achievable by a processor and therefore can further be organized into micro-instructions (e.g., a set of micro-operations executed simultaneously).

As further illustrated in FIG. 1, processor 110 includes a processing circuit 112, multi-format operand instructions 114, and a register 116. Processing circuit 112 corresponds to a processing component and in some examples includes circuitry and/or instructions for floating point number conversion operations and/or portions thereof, and further in some examples can correspond to and/or interface with a floating point unit (FPU) for performing floating point operations. Multi-format operand instructions 114 correspond to circuitry and/or instructions for performing floating point operations using operands of different floating point formats. In some examples, multi-format operand instructions 114 can correspond to micro-operations that can be loaded and/or hard-wired into processing circuit 112. Register 116 corresponds to a local storage of processor 110, such as for temporarily holding data for processing. As will be described further below, processing circuit 112 can perform floating point operations directly using two operands without having to convert either to a shared floating point format.

FIGS. 2A-2C respectively illustrate a number format 200, a number format 202, and a number format 204, each corresponding to floating point formats of different precisions (e.g., bit widths). For example, FIG. 2A illustrates an example 8-bit precision floating point number format, FIG. 2B illustrates an example 16-bit precision floating point number format, and FIG. 2C illustrates an example 32-bit precision floating point number format.

A floating point number corresponds to a real number value represented with significant digits and a floating radix point. For example, a decimal (real) number 432.1 can be represented, by moving (e.g., floating) the base-10 radix point (e.g., decimal point), as 4321*10\hat{ }−1, allowing a real number value to be represented by an integer (e.g., mantissa or significand) scaled by an integer exponent of a base. Because computing systems store bit sequences which are readily converted to binary (e.g., base 2) numbers, computing systems often use a base-2 radix point. For instance, 0.5 can be represented as 1*2 −1. Thus, in a binary representation of a floating point number, a real number value, Value, can be represented by the following equation:

$$Value = {( - 1 )}^{Sign} * Normalized\_Mantissa * {2}^{Exponent - Bias} \qquad Equation 1$$

Sign can indicate whether the value is positive (e.g., Sign=0) or negative (e.g., Sign=1). Normalized_Mantissa can correspond to a mantissa (e.g., as stored in a bit sequence) that has been normalized in accordance with a floating point number format. A non-zero binary number can have its radix point floated such that its mantissa can always have a leading 1 (e.g., “1.01”). Accordingly, many floating point number formats will not explicitly store this leading 1, as it is understood (e.g., when normalized). Exponent-Bias corresponds to the final exponent of the value after subtracting Bias from Exponent. Many floating point number formats use a bias to avoid using a sign bit (e.g., for negative exponents), which can further allow efficient processing between two floating point numbers. Thus, Exponent can correspond to the stored exponent value, and Bias can be a value defined for the specific floating point number format. Further, floating point number formats can define how bits in an allotted bit width can be decoded or interpreted. Thus, certain bits can be reserved for representing Sign, certain bits can be reserved for representing Exponent, and certain bits can be reserved for representing a Mantissa that can require normalizing.

Turning to FIG. 2A, number format 200 represents an example of an 8-bit floating point number format (e.g., having an 8-bit width or precision such as quarter-precision). Number format 200 can define what each bit position of the 8-bit format represents. As illustrated in FIG. 2A, a single bit (e.g., bit 7) can correspond to a sign bit (e.g., Sign), four bits (e.g., bits 3-6 from least to most significant bits) can correspond to an exponent (e.g., Exponent), and three bits (e.g., bits 0-2 from least to most significant bits) can correspond to a mantissa. In other number formats, a number and/or order of bits for the various elements can vary. In addition, a bias (e.g., Bias) can be defined for number format 200. For example, the bias can be 7, corresponding to exponents ranging from −6 to 7, which are derived from subtracting the bias 7 from a range of 1-14 for the four bits (leaving “0” or all 0s and “15” or all 1s for special values). The bias can be based on the number of exponent bits. In some examples, the bias allows certain bit sequences (e.g., bit sequences having the exponent being all 0, as well as other particular bit sequences such as all 0, etc.) to represent special values (e.g., subnormal values, positive/negative zero, positive/negative infinity, undefined/not a number (NaN), etc.).

FIG. 2B illustrates number format 202 that represents an example of a 16-bit floating point number format (e.g., half-precision). As illustrated in FIG. 2B, a single bit (e.g., bit 15) can correspond to a sign bit (e.g., Sign), five bits (e.g., bits 10-14 from least to most significant bits) can correspond to an exponent (e.g., Exponent), and ten bits (e.g., bits 0-9 from least to most significant bits) can correspond to a mantissa. The bias can be based on the number of exponent bits, such as 15, which can further reserve certain bit sequences as special values as described herein. In other examples, number format 202 can have different number and/or order of bits for the various elements.

FIG. 2C illustrates number format 204 that represents an examples of a 32-bit floating point number format (e.g., single-precision). As illustrated in FIG. 2C, a single bit (e.g., bit 31) can correspond to a sign bit (e.g., Sign), eight bits (e.g., bits 23-30 from least significant to most significant bits) can correspond to an exponent (e.g., Exponent), and twenty-three bits (e.g., bits 0-22 from least significant to most significant bits) can correspond to a mantissa. The bias can be based on the number of exponent bits, such as 127, which can further reserve certain bit sequences as special values as described herein. In other examples, number format 204 can have different number and/or order of bits for the various elements.

In some examples, system 100 (e.g., processor 110) can be configured with circuitry and/or instructions for particular floating point number formats. For example, certain elements of a number format (e.g., bias, special value sequences, etc.) can be incorporated into the circuitry and/or instructions without explicitly storing such elements in the floating point number (e.g., bit sequence) itself. In some implementations, processor 110 can include circuitry and/or instructions for each supported floating point number format (e.g., processing circuit 112 and/or multi-format operand instructions 114 can correspond to multiple iterations).

In some examples, processor 110 can be configured to accept and process values in different floating point number formats. As described above, floating point number formats can have a similar precision (e.g., bit width) yet different number of bits and/or order of bits for the various elements. For example, number format 200 illustrates 4 exponent bits followed by 3 mantissa bits. Another similar bit-width format can be defined with 3 exponent bits followed by 4 mantissa bits. Moreover, bias values can differ for otherwise similar number formats. Thus, when processor 110 processes two operands of different floating point number formats, processor 110 can convert a first operand into a format of the second operand to process the two operands in the same format. In some cases, processor 110 converts operands into a format for which processor 110 is directly configured to process.

However, it can be desirable to forego converting values between different number formats. For instance, processor 110 can receive and process data from a first source (e.g., as the first operand) and receive/process data from a second source (e.g., as the second operand). The first source can correspond to a first dataset having data encoded in a first number format, and the second source can correspond to a second dataset having data encoded in a second number format. Although in some cases, processor 110 can pre-convert the second dataset into the first number format, such pre-conversion can be unavailable (e.g., for dynamically generated data) or can incur significant latency. Alternatively, processor 110 can convert the second operand prior to each operation, which can undesirably incur latency, such as for common and repeated operations.

FIG. 3 illustrates a processor 310 (corresponding to processor 110), that can perform operations directly with operands of different number formats. FIG. 3 includes a first operand register 332 (corresponding to an iteration of register 116), a second operand register 334 (corresponding to another iteration of register 116), an output register 336 (corresponding to yet another iteration of register 116), a floating point unit 312 (corresponding to processing circuit 112), and multi-format operand instructions 314 (corresponding to multi-format operand instructions 114).

First operand register 332 can be configured to load a value in a first floating point number format. In some implementations, first operand register 332 can be configured to load data from a first source, such as a particular device, component, and/or portion of memory (e.g., memory 120). Further, in some implementations, the first floating point number format can be linked to the first source, although in other implementations the first floating point number format can be identified when loaded. Similarly, second operand register 334 can be configured to load a value in a second floating point number format, which in some implementations can correspond to a second source. In some examples, the first and second floating point formats can vary. Moreover, in some examples, the first and second floating point formats can correspond different number formats to a similar precision (e.g., bit width), although in other examples can correspond to different precisions.

Floating point unit 312 can perform floating point operations on the values stored in first operand register 332 and second operand register 334. Floating point unit 312 can load or otherwise be hard-wired (e.g., as circuitry) with instructions (e.g., micro-operations) for performing various floating point operations, such as arithmetic operations with floating point numbers as operands. As described herein, rather than converting values stored in first operand register 332 and/or second operand register 334, floating point unit 312 can directly use the values in their respective original formats.

When decoding a floating point operation into micro-operations, floating point unit 312 can select appropriate micro-operations (e.g., multi-format operand instructions 314) for the operation based on the first and second floating point number formats. In some examples, multi-format operand instructions 314 can include or be selected from multiple sets of micro-operations corresponding to possible combinations of number formats as operands. For example, for all of the floating point number formats that floating point unit 312 can support, every combination of selecting input and output formats (e.g., at least two formats for the two operands and at least an output format) can be represented with a set of micro-operations, further applied to each supported floating point operation. In some implementations, a different order of operands can require a different set of micro-operations. Floating point unit 312 can identify the floating point number formats (e.g., based on a source of the values and/or in some examples, based on identifying the registers). Accordingly, floating point unit 312 can use an appropriate set of micro-operations (e.g., multi-format operand instructions 314) out of the possible combinations that directly use the values from first operand register 332 and second operand register 334 without requiring an intermediary conversion operation.

The set of micro-operations can include micro-operations for completing the floating point operations. In some examples, multi-format operand instructions 314 can include micro-operations for normalizing signs, exponents, and mantissas of the two operands, further allowing combining the signs, exponents, and/or mantissas in accordance with the operation to produce an output result that can be stored in output register 336. In some examples, the output result can be in one of the formats of either operand, such as the first floating point number format or the second floating point number format, although in other examples the output result can be in another desired floating point number format. Accordingly, in some implementations, multi-format operand instructions 314 can include instructions (e.g., micro-operations) that can produce outputs in the desired floating point number format.

In addition, in some implementations, floating point unit 312 can perform operations with three operands. For example, floating point unit 312 can read a third operand in a third floating point format (which can be similar and/or different from either of formats for the first operand or the second operand) from a third operand register 333 (corresponding to register 116). In some examples, multi-format operand instructions 314 can include micro-operations for performing the operation using the three operands directly. In some examples, floating point unit 312 can perform the operation with the three operands as broken into sub-operations, such as a primary operation directly using the first operand and the second operand to produce an initial result, and performing a secondary operation directly using the third operand and the initial result (e.g., as an operand) to produce the final output result.

Moreover, although not shown in FIG. 3, floating point unit 312 can be configured to perform operations on any number of input operands in any number format (e.g., any floating point number format, integer number format, etc. of similar or different precisions) to produce one or more output results in any number format. In other words, multi-format operand instructions 314 can include micro-operations for performing arithmetic/logic operations directly on any desired number of operands in any desired combination of number formats to produce any number of desired output results in any desired combination of number formats.

FIG. 4 is a flow diagram of an exemplary computer-implemented method 400 for hardware-based multi-format operand processing. The steps shown in FIG. 4 can be performed by any suitable circuit, device, and/or computing system, including the system(s) illustrated in FIGS. 1 and/or 3. In one example, each of the steps shown in FIG. 4 represent an algorithm whose structure includes and/or is represented by multiple sub-steps, examples of which will be provided in greater detail below.

As illustrated in FIG. 4, at step 402 one or more of the systems described herein identify a first number format for a first operand of an operation and a second number format, for a second operand of the operation, that is different a number format having a similar precision. For example, processing circuit 112 can identify number formats of a first operand and a second operand of an operation. The identified number formats can be different floating point number formats of a similar precision. In other examples, the number formats can correspond to other scalar number formats, such as integer formats.

At step 404 one or more of the systems described herein select, based on the first number format and the second number format, a set of instructions that use the first number format and the second number format to perform the operation. For example, processing circuit 112 can select multi-format operand instructions 114 that uses the two identified floating point number formats to perform the operation.

The systems described herein can perform step 404 in a variety of ways. In some examples, selecting the set of instructions is based on the first number format and the second number format. In some examples, selecting the set of instructions is based on a first source of the first operand and a second source of the second operand.

As illustrated in FIG. 4, at step 406 one or more of the systems described herein perform the operation by directly using the first operand and the second operand with the selected set of instructions to produce an output result. For example, processing circuit 112 can perform the operation by directly using the first and second operands with multi-format operand instructions 114.

The systems described herein can perform step 406 in a variety of ways. In one example, performing the operation can further include normalizing a first sign, a first exponent, and a first mantissa of the first operand based on the first number format, and normalizing a second sign, a second exponent, and a second mantissa of the second operand based on the second number format. Processing circuit 112 can further perform the operation by combining the first sign with the second sign, the first mantissa with the second mantissa, and the first exponent with the second exponent in accordance with the operation to produce the output result. Moreover, in some examples, processing circuit 112 can further perform the operation directly using a third operand in a third number format to produce the output result. For instance, as described above, processing circuit 112 can use multi-format operand instructions 114 for having three operands of any combination of number formats. Alternatively, as described above, processing circuit 112 can perform a primary operation directly using the first operand in the first number format and the second operand in the second number format, producing an initial result, and performing a secondary operation directly using the third operand in the third number format and the initial result to produce the output result.

As detailed above, certain arithmetic operation combinations are commonly used (e.g., for address translation), such as D=C+A×B, where D is a final destination, C is a partial sum, and A and B are operands. The operands A and B are normally the same format, such as both being FP32, BF8, FP8, etc., for the operation. However, certain formats are variants of each other, such as BF8 and FP8 both being 8-bit floating point formats that are commonly used, although many architectures support only one 8-bit floating point format. Thus, for some architectures, if the operands are not the same format, the operation would not be possible, or would require a conversion of one or both operands into a compatible format for the operation. For instance, for a dataset for inference or training, half of the dataset values can be BF8 (e.g., generated or otherwise provided by a first data source or device) and the other half can be FP8 (e.g., generated or otherwise provided by a second data source or device) such that half of the values would first need to be converted/stored.

The systems and methods described herein allows a processor to complete an operation mixed operands formats, particularly for related variants of same widths (such as BF8 and FP8). For example, with BF8 and FP8, the systems and methods provided allows the 4 possible combinations of A and B for the two formats (e.g., BF8 and BF8, BF8 and FP8, FP8 and FP8, and FP8 and BF8), which in some implementations can double to 8 combinations if bias mode switching is available for the floating point formats. By covering all the combinations, the systems and methods described herein provides more flexibility for formats. Accordingly, the systems and methods described herein allows operands of different formats to be used without having to first convert one or both operands. This advantageously allows faster convergence, overall reductions of power consumption, efficiency, etc.

As detailed above, the computing devices and systems described and/or illustrated herein broadly represent any type or form of computing device or system capable of executing computer-readable instructions. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a processing circuit configured to perform an operation with a first operand having a first number format and a second operand having a second number format by directly using the first operand in the first number format and the second operand in the second number format to produce an output result.

2. The device of claim 1, wherein the first number format and the second number format correspond to different number formats of a plurality of number formats that have a similar precision and the processing circuit is configured to perform the operation for each of a plurality of possible combinations of the plurality of number formats for the first operand and the second operand.

3. The device of claim 2, wherein the processing circuit includes circuitry, for each of the plurality of possible combinations, to perform the operation.

4. The device of claim 2, wherein the processing circuit includes instruction sets, for each of the plurality of possible combinations, to perform the operation.

5. The device of claim 2, wherein the processing circuit is further configured to decode the operation into micro-operations that use the first number format and the second number format.

6. The device of claim 5, wherein the micro-operations include micro-operations for normalizing a first sign, a first exponent, and a first mantissa of the first operand based on the first number format and normalizing a second sign, a second exponent, and a second mantissa of the second operand based on the second number format.

7. The device of claim 6, wherein the micro-operations include micro-operations for combining the first sign with the second sign, the first mantissa with the second mantissa, and the first exponent with the second exponent in accordance with the operation to produce the output result.

8. The device of claim 1, wherein the processing circuit is further configured to perform the operation with a third operand having a third number format by directly using the third operand in the third number format to produce the output result.

9. The device of claim 8, wherein the processing circuit is configured to perform the operation with the first operand, the second operand, and the third operand by:
performing a primary operation directly using the first operand in the first number format and the second operand in the second number format to produce an initial result; and
performing a secondary operation directly using the third operand in the third number format and the initial result to produce the output result.

10. A system comprising:
a memory; and
a processing circuit configured to:
receive, for an operation, a first operand from the memory having a first number format and a second operand having a second number format;
decode the operation into micro-operations that use the first number format and the second number format; and
perform the operation via the decoded micro-operations that directly use the first operand in the first number format and the second operand in the second number format to produce an output result.

11. The system of claim 10, wherein the first number format and the second number format correspond to different number formats of a plurality of number formats that have a similar precision.

12. The system of claim 11, wherein the processing circuit is configured to decode the operation into micro-operations by selecting the micro-operations corresponding to one of a plurality of possible combinations of the plurality of number formats for the first operand and the second operand.

13. The system of claim 12, wherein the processing circuit is further configured to select the micro-operations based on a first source of the first operand and a second source of the second operand.

14. The system of claim 10, wherein the micro-operations include micro-operations for:
normalizing a first sign, a first exponent, and a first mantissa of the first operand based on the first number format;
normalizing a second sign, a second exponent, and a second mantissa of the second operand based on the second number format; and
combining the first sign with the second sign, the first mantissa with the second mantissa, and the first exponent with the second exponent in accordance with the operation to produce the output result.

15. The system of claim 10, wherein the processing circuit is further configured to perform the operation with a third operand having a third number format by directly using the third operand in the third number format to produce the output result.

16. A method comprising:
identifying a first number format for a first operand of an operation and a second number format for a second operand of the operation, wherein the first number format and the second number format correspond to different number formats that have a similar precision;
selecting, based on the first number format and the second number format, a set of instructions that use the first number format and the second number format to perform the operation; and
performing the operation by directly using the first operand and the second operand with the selected set of instructions to produce an output result.

17. The method of claim 16, wherein selecting the set of instructions is based on the first number format and the second number format.

18. The method of claim 16, wherein performing the operation further comprises:
normalizing a first sign, a first exponent, and a first mantissa of the first operand based on the first number format; and
normalizing a second sign, a second exponent, and a second mantissa of the second operand based on the second number format.

19. The method of claim 18, wherein performing the operation further comprises combining the first sign with the second sign, the first mantissa with the second mantissa, and the first exponent with the second exponent in accordance with the operation to produce the output result.

20. The method of claim 16, wherein performing the operation further comprises performing the operation with a third operand having a third number format by directly using the third operand in the third number format to produce the output result.
